(19) United States
(12) Patent Application Publication
(10) Pub. No.: US 2007/0245780 A1
(43) Pub. Date: Oct. 25, 2007

(54) LOCK AND DOOR MODULE ASSEMBLY

(76) Inventors: Francois-Paul Meurou, Sceaux Du Gatinais (FR); Stephane Hemond, Les Bordes (FR); Stephanie Brien, Chateauneuf Sur Loire (FR); Frederic Burkat, Bouzy La Foret (FR)

Correspondence Address: CARLSON, GASKEY & OLDS, P.C., 400 WEST MAPLE ROAD, SUITE 350, BIRMINGHAM, MI, 48009, US

(21) Appl. No.: 11/739,225

(22) Filed: Apr. 24, 2007

(30) Foreign Application Priority Data
Apr. 25, 2006 (FR) 06 03 659

(51) Int. Cl. E05B 65/00

(52) U.S. Cl. 70/91

(57) ABSTRACT

An assembly includes a lock and a door module, the module separating a dry zone and a wet zone. The door module includes an interface for attachment of the lock, the attachment interface being the only passage for the lock from one zone to the other zone. A door can include the assembly. The assembly of the lock to the door module is simplified, and in particular, a configuration of the door module is simplified.

### REFERENCE TO RELATED APPLICATIONS

This application claims priority to French Patent Application FR 06 03 659 filed on Apr. 25, 2006.

### BACKGROUND OF THE INVENTION

This invention relates generally to a lock and door module assembly. In particular, the door module is a vehicle door module.

A vehicle door can includes a module on which a lock is attached. The lock can be in contact with the module at several points, in particular at a point of attachment of the lock to the module and at points where components relating to the lock pass through the module.

The drawback is that the module must have a complex configuration to fit the contact points between the lock and the module.

A need therefore exists for a simpler lock to door module assembly.

### SUMMARY OF THE INVENTION

The present invention provides an assembly including a lock and a door module that separates a dry zone and a wet zone. The door module includes a lock attachment interface that is the only passage for the lock from one zone to the other zone.

According to another characteristic, the lock includes control components for control of the lock, the components extending from one zone to the other zone through the lock attachment interface. According to another characteristic, the control components include an inner lock release cable. According to another characteristic, the control components include a wiring harness that supplies electrical power to the lock. According to another characteristic, the lock includes a fastener for attachment to the lock attachment interface. According to another characteristic, the fastener includes an opening for passage from one zone to the other zone. According to another characteristic, the lock includes a casing, and the fastener is in a single piece with the casing. According to another characteristic, the lock includes a seal in the fastener. According to another characteristic, the fastener is a flexible attachment. According to another characteristic, the fastener is an attachment that can be uncoupled. According to another characteristic, the assembly includes a seal between the door module and the lock. According to another characteristic, the lock includes control components, the components extending from one zone to the other zone through the seal between the door module and the lock.

The invention also provides a vehicle door including a dry zone, a wet zone and the assembly as described above.

### BRIEF DESCRIPTION OF THE DRAWINGS

Other characteristics and advantages of the invention will become apparent when reading the following detailed description of the embodiments of the invention, given as an example only and with reference to the drawings, in which:

FIG. 1 illustrates a cross-section of a vehicle door; and

FIG. 2 illustrates a detailed view of the vehicle door of FIG. 1.

### DETAILED DESCRIPTION OF THE INVENTION

The invention provides an assembly including a lock and a door module. The door module forms a separation between a dry zone and a wet zone. The door module includes a lock attachment interface, the attachment interface being the only passage for the lock between the two zones. This allows for simpler assembly of the lock on the door module, and in particular a simpler configuration of the door module because the number of points of contact between the door module and the lock is reduced. This also simplifies the mounting of the door.

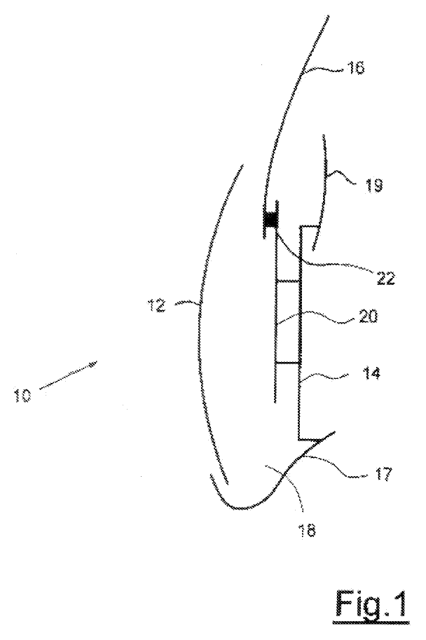

FIG. 1 shows a cross-section of a vehicle door 10. The vehicle door 10 includes an outer skin 12 and an inner skin 14. The outer skin 12 faces the outside of the vehicle and is constituted by a body at the vehicle. The inner skin 14 faces the inside of the vehicle. The outer skin 12 and the inner skin 14 define a shell 18 of the vehicle door 10. The shell 18 is delimited transversely by the outer skin 12 and the inner skin 14. The shell 18 is also delimited in a direction of movement of the vehicle by the door edges, not shown. The shell 18 is delimited longitudinally by the edges. A window 16 is able to enter and exit from the vehicle door 10, in particular from the shell 18. The window 16 is, for example, actuated by a window regulator, a rail 20 of which is shown. A slide 22 makes it possible to guide the movement of the window 16 upwards and downwards along the rail 20.

A wet zone W of the vehicle door 10 is between the outer skin 12 and the inner skin 14 (the shell 18). The wet zone W is not insulated from external moisture. The inner skin 14 separates the wet zone W from the inside of the vehicle. The inside of the vehicle is considered to be a dry zone. D. The components of the vehicle door 10 situated in the dry zone D are protected from external moisture. In one example, the components of the vehicle door that are moisture-sensitive are situated in the dry zone D. In one example, the inner skin 14 is covered with a door trim covering (not shown).

The vehicle door 10 can include different components. As an example, the window regulator already referred to above can be included. The window regulator can be electric, with the movement of the slide 22 and the window 16 being provided by an electric motor. In one example, the electric motor is in the dry zone D to be insulated from the stresses of external moisture. As an example of other components of the vehicle door 10, a door lock 28 can also be included.

The vehicle door 10 can include a door module. The door module 14 is partly the inner skin 14. The door module 14 is in the plane of the vehicle. The shell 18 is delimited transversely partly by the door module 14. The door module 14 can create a separation between the wet zone W and the dry zone D. The door module 14 can also allow for the holding of at least some of the aforementioned components in the vehicle door 10, mounted in the vehicle door 10, and/or be used to carry others. The advantage is in particular in the mounting of the aforementioned components directly on the door module 14, then mounting the door module 14 on the vehicle door 10. The door module 14 and the vehicle door 10 components together thus form an assembly mounted as a unit on the vehicle door 10. This makes it possible to simplify the assembly of the door components on the vehicle door 10. Thus, the window regulator and the lock 28 can be mounted on the door module 14 before attachment of the door module 14 to the vehicle door 10. The mounting of the door module 14 on the vehicle door 10 makes it possible to close the door shell 18 and to separate the wet zone W and the dry zone D.

According to FIG. 1, the door module 14 is attached to a bottom 17 of the vehicle door 10 and to a protective molding 19 of the vehicle door 10. The door module 14 is, for example, a plate formed to fit the vehicle door 10. The plate is also formed to fit the components to be held. The plate is, for example, made of plastic or steel. A plastic plate can be injected or injected and compressed, and a steel plate is stamped. The plate is formed to carry the rail 20 and hold the rail 20 in place in the shell 18. The plate is also formed to carry the lock 28 and hold the lock 28 in place in the vehicle door 10.

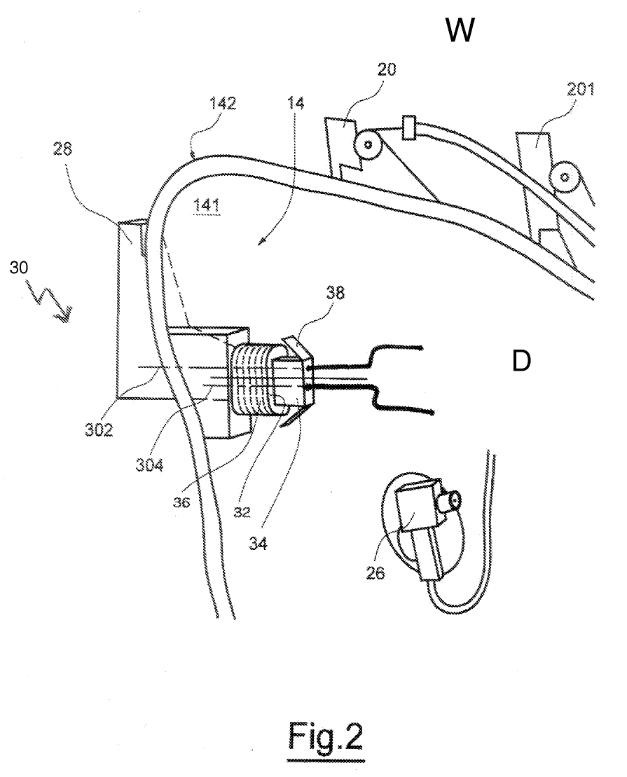

FIG. 2 shows a detail of the vehicle door 10 in FIG. 1. FIG. 2 shows in particular a part of the door module 14. Also visible are two rails 20 and 201 of the window regulator, as well as a motor 26 for activation of the window regulator. A lock 28 is also shown. A visible face 141 of the door module 14 is the face of the door module 14 facing the inside of the vehicle, i.e., towards the dry zone D. A face 142 opposite the face 141 is facing the door shell 18, i.e., towards the wet zone W. The motor 26 is assembled on the face 141 in the dry zone D. The rails 20 and 201 are assembled on the face 142 in the wet zone W. Moreover, the lock 28 is positioned in the wet zone W, but extends towards the dry zone D, as will be explained in more detail.

The lock 28 makes it possible to immobilize the vehicle door 10 relative to the vehicle in the closed position of the vehicle door 10. In one example, the lock 28 is mounted on an edge of the vehicle door 10. When the vehicle door 10 is closed, a latch of the lock 28 is hooked to a striker mounted on the vehicle.

In one example, the lock 28 is mounted in the shell 18 of the vehicle door 10 for aesthetic purposes. Thus, in FIG. 2, it can be seen that the lock 28 is assembled on the face 142 of the door module 14 in the wet zone W. However, the lock 28 can include components 30 extending from one zone to the other zone. As examples of components 30, the lock 28 can include lock control components, such as an inner lock release cable 302. Such a control is a cable extending from an inner door handle to the lock 28. The actuation of the handle allows for the release of the lock 28 by the cable. Because the inner door handle is inside the vehicle while the lock 28 is in the shell 18, the cable extends from one zone to the other zone. Moreover, the lock control components 30 can also be a wiring harness 304 for supplying electrical power to the lock 28. In this last case, the lock 28 is an electric lock. The activation of the lock 28 is electric, with one or more electric motors or actuators driving the components of the lock 28, for example for the central locking of the vehicle. This or these electric motors or actuators are powered by the wiring harness 304. The wiring harness 304 originates from the dry zone D and extends to the lock 28 in the wet zone W.

A passage for the lock 28 can be provided through the door module 14. The passage for the lock 28 is in particular provided through the inner skin 14 of the vehicle door 10. In particular, the door module 14 can be formed to include an attachment interface 32 for attachment of the lock 28 to the door module 14, the attachment interface 32 ensuring the passage for the lock 28 between the wet zone W and the dry zone D. This makes it possible to take advantage of the configuration of the door module 14 that is provided for the attachment of the lock 28 to provide a passage for the lock 28 through the door module 14. This makes it possible to reduce the number of points of contact between the lock 28 and the door module 14, which facilitates the construction of the door module 14. In particular, this makes it possible to reduce the number of openings for passage of the lock 28 through the door module 14, which makes it possible to reduce the use of seals on these openings. This makes it possible to reduce the production costs of the door module 14. In one example, the attachment interface 32 is the only passage for the lock 28 between the wet zone W and the dry zone D. The attachment interface 32 is the only passage for the lock 28 through the door module 14. This makes it possible to produce only one opening for passage of the lock 28, which further facilitates the production of the door module 14. In particular, as there is only one opening for the lock 28 through the door module 14, this makes it possible to provide only one seal is provided between the lock 28 and the door module 14. The production costs for the assembly of the lock 28 to the door module 14 are reduced.

The attachment interface 32 includes a passage through the door module 14 for the lock 28, making it possible to pass components of the lock 28 from one zone to the other zone. For example, these components are the lock control components 30. The lock control components 30 can also be structural components of the lock 28, such as a fastener 34 attaching the lock 28 to the door module 14. As a result of the attachment interface 32 allowing the passage of the lock 28, it is possible to avoid having to form the door module 14 at one point for the passage of the component inner lock release cable 302, at one point for the passage of the wiring harness 304, and at another point for the attachment of the lock 28. There is only one point of contact between the lock 28 and the door module 14.

FIG. 2 shows the fastener 34 attaching the lock 28 to the door module 14. The fastener is of any type. For example, according to FIG. 2, the fastener 34 is elastic and is of a clip type, which facilitates the attachment of the lock 28 to the door module 14. The fastener 34 includes tabs 38 allowing for the insertion of the lock 28 through the passage in one direction, and the blocking of the lock 28 in the other direction. The tabs 38 ensure the blocking of the lock 28 by abutting against the attachment interface 32 when the lock 28 is pulled to the left of FIG. 2. Alternatively, and with the same advantages, the attachment interface 32 can include a clip-type fastener, cooperating with a component of the fastener 34, of a groove type. In all these methods of attachment of the lock 28 to the door module 14, the attachment is simple and prevents any untimely release. In these attachment methods described, provision can also be made for the attachment of the lock 28 to the door module 14 to be released, i.e., for an operator to uncouple the lock 28 from the door module 14 for maintenance operations on one or other of the components. In FIG. 2, this release takes place by pressing on the tabs 38 to withdraw the lock 28 to the left of the figure. Moreover, the fastener 34 also includes an opening for passage from one zone to the other zone. For example, through the opening of the fastener 34, the lock control components 30 can extend from one zone to the other zone. Once the lock 28 is in place, by attachment of the lock 28 to the attachment interface 32, one part of the lock 28 is in the wet zone W, and another part of the lock 28 is in the dry zone D.

The fastener 34 described allows for the attachment of the lock 28 to the door module 14.

However, the lock 28 is also attached by other conventional ways to the vehicle door 10, and in particular on the edge of the vehicle door 10. Thus, the fastener 34 allows for provisional and preliminary attachment of the lock 28 to the door module 14 before mounting in the vehicle door 10. Once the door module 14 is attached to the vehicle door 10, and in particular once the door module 14 is attached to the shell 18 of the vehicle door 10, the lock 28 is also attached to an edge of the vehicle door 10. Clearance can be provided between the fastener 34 and the door module 14 to allow for permanent attachment to the edge of the vehicle door 10. The fastener 34 thus makes it possible to facilitate the mounting in the vehicle door 10 of the lock 28 and of the door module 14.

The lock 28 includes a casing. In FIG. 2, the lock 28 is shown only by the casing. The operating system of the lock 28 is housed in the casing. The casing makes it possible to attach the lock 28 to the door module 14 and to insulate the operating system of the lock 28 within the wet zone W. Preferably, the fastener 34 is in a single piece with the casing of the lock 28, making it possible to produce the fastener 34 more easily and reduces the number of individual parts.

The lock 28 and door module 14 assembly can also include a seal 36. The seal 36 allows for sealing between the dry zone D and the wet zone W at the point of attachment of the lock 28 to the door module 14. When the lock 28 is in place on the door module 14, the seal 36 is on the attachment interface 32, the fastener 34 is in the dry zone D and the casing is in the wet zone W. The seal 36 is, for example, a gaiter seal. It may also be envisaged that the fastener 34 is not in a single piece with the casing of the lock 28, but rather is attached to the casing by the seal 36. Moreover, the lock control components 30 can extend from one zone to the other zone through the seal 36. The inner lock release cable 302 and the wiring harness 304 do not then extend through the fastener 34.

Furthermore, the lock 28 can also include another seal for ensuring sealing between the two zones W and D. The lock seal is, for example, in the passage opening in the fastener 34. The lock control components 30 can extend from one zone to the other zone through the fastener seal. This seal can be provided with holes through which the lock control components 30 are drawn.

Thus, the lock control components 30 can extend through the interface from one zone to the other zone through the seal 36 situated between the door module 14 and the lock 28 or through the seal situated in the fastener 34. One or other of the solutions is adopted according to the space available and according to the shape to be given to the seal. The lock control components 30 can also each pass through one of the seals.

Of course, this invention is not limited to the embodiments described as an example. Thus, it is not limited to the components of the lock described and which extend from one zone to the other zone.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

What is claimed is:

1. An assembly comprising:
a lock; and
a door module separating a dry zone and a wet zone, wherein the door module includes an attachment interface for attachment of the lock, the attachment interface being the only passage for the lock between the dry zone and the wet zone.

2. The assembly according to claim 1, wherein the lock includes control components for control of the lock, the control components extending between the dry zone and the wet zone through the attachment interface.

3. The assembly according to claim 2, wherein the control components include an inner lock release cable.

4. The assembly according to claim 2, wherein the control components include a wiring harness for supplying electrical power to the lock.

5. The assembly according to claim 1, wherein the lock includes a fastener for attachment to the attachment interface.

6. The assembly according to claim 5, wherein the fastener includes an opening for passage between the dry zone and the wet zone.

7. The assembly according to claim 6, wherein the lock includes a casing, and the fastener is in a single piece with the casing.

8. The assembly according to claim 5, wherein the lock includes a seal in the fastener.

9. The assembly according to claim 5, wherein the fastener is flexible.

10. The assembly according to claim 5, wherein the fastener can be uncoupled from the attachment interface.

11. The assembly according to claim 1, further including a seal between the door module and the lock.

12. The assembly according to claim 11, wherein the lock includes control components, the control components extending between the dry zone and the wet zone through the seal between the door module and the lock.

13. An assembly comprising:
a door module that separates a dry zone and a wet zone, wherein the door module includes an attachment interface for attachment of a lock, the attachment interface being the only passage for the lock between the dry zone and the wet zone; and
the lock including a fastener for attachment to the attachment interface, wherein the fastener includes an opening for passage between the dry zone and the wet zone.

14. The assembly according to claim 13, wherein the lock includes control components for control of the lock, the control components extending between the dry zone and the wet zone through the attachment interface.

15. The assembly according to claim 13, wherein the lock includes a casing, and the fastener is in a single piece with the casing.

16. The assembly according to claim 13, further including a seal between the door module and the lock, wherein the lock includes control components, the control components extending between the dry zone and the wet zone through the seal between the door module and the lock.

17. A vehicle door comprising:
a dry zone;
a wet zone; and
an assembly including a lock and a door module that separates the dry zone and the wet zone, wherein the door module includes an attachment interface for attachment of the lock, the attachment interface being the only passage for the lock between the wet zone and the dry zone.

18. The vehicle according to claim 17, wherein the lock includes control components for control of the lock, the control components extending between the dry zone and the wet zone through the attachment interface.

19. The vehicle according to claim 17, wherein the lock includes control components for control of the lock, the control components extending between the dry zone to the wet zone through the attachment interface.

20. The vehicle according to claim 17, wherein the lock includes a casing, and the fastener is in a single piece with the casing.
